(19) United States
(12) Patent Application Publication
(10) Pub. No.: US 2026/0233520 A1
(43) Pub. Date: Aug. 13, 2026

(54) LIQUID DROPLET DISCHARGE HEAD AND DROPLET DISCHARGE APPARATUS

(71) Applicant: KYOCERA Corporation, Kyoto (JP)

(72) Inventors: Naoto MIYAKOSHI, Osaka-shi, Osaka (JP); Masaru IWABUCHI, Kirishima-shi, Kagoshima (JP); Fumito NAKAMOTO, Kirishima-shi, Kagoshima (JP)

(21) Appl. No.: 19/148,000

(22) PCT Filed: Jan. 23, 2024
(86) PCT No.: PCT/JP2024/001844

§ 371 Date: Jul. 15, 2025

(30) Foreign Application Priority Data
Jan. 23, 2023 (JP) 2023-008335

(51) Int. Cl. B41J 2/14

(52) U.S. Cl. CPC B41J 2/14201; B41J 2002/14362; B41J 2002/14491; B41J 2202/08; B41J 2202/19

(57) ABSTRACT

A liquid droplet discharge head according to the present disclosure includes a channel member, a branched channel member, and a reservoir. The channel member includes a plurality of discharge holes for discharging droplets. The branched channel member is located over the channel member, and includes a branched channel connected to the channel member. The reservoir is located over the branched channel member, and configured to supply liquid to the branched channel member. The branched channel member has a box shape.

### CROSS-REFERENCE TO RELATED APPLICATIONS

This application is national stage application of International Application No. PCT/JP2024/001844, filed on Jan. 23, 2024, which designates the United States, and which claims the benefit of priority from Japanese Patent Application No. 2023-008335, filed on Jan. 23, 2023.

### TECHNICAL FIELD

The present disclosure relates to a liquid droplet discharge head and a droplet discharge apparatus.

### BACKGROUND OF INVENTION

In the related art, as a printing head, a liquid discharging head that performs various printing by discharging liquid onto a recording medium is known, for example. Patent Document 1 discloses an ink-jet head including a planar laminated flow channel unit including an ink channel that guides to the ink outlet the ink supplied from the ink supply port.

### CITATION LIST

### Patent Literature

Patent Literature 1: Japanese Patent Application Laid-Open No. 2004-114404

### SUMMARY

A liquid droplet discharge head according to the present disclosure includes a channel member, a branched channel member, and a reservoir. The channel member includes a plurality of discharge holes for discharging droplets. The branched channel member is located over the channel member, and includes a branched channel connected to the channel member. The reservoir is located over the branched channel member, and configured to supply liquid to the branched channel member. The branched channel member has a box shape.

### BRIEF DESCRIPTION OF THE DRAWINGS

FIG. 1 is a schematic side view of a printer according to a first embodiment.

FIG. 2 is a schematic plan view of the printer according to the first embodiment.

FIG. 3 is an exploded perspective view illustrating a schematic configuration of a liquid droplet discharge head according to the first embodiment.

FIG. 4 is an enlarged sectional view taken along line IV-IV of FIG. 3.

FIG. 5 is a perspective view for describing a structure of a branched channel member according to the first embodiment.

FIG. 6 is a schematic plan view of the branched channel member according to the first embodiment.

FIG. 7 is a schematic front view of the liquid droplet discharge head according to the first embodiment.

FIG. 8 is a schematic front view of the liquid droplet discharge head according to the first embodiment.

FIG. 9 is an enlarged perspective view of the liquid droplet discharge head according to the first embodiment.

FIG. 10 is an exploded perspective view illustrating a schematic configuration of a liquid droplet discharge head according to a second embodiment.

FIG. 11 is a schematic perspective view illustrating configurations of a wiring board, a first supporting member and a second supporting member according to the second embodiment.

FIG. 12 is a schematic perspective view illustrating a configuration of a pressing member according to the second embodiment.

FIG. 13 is a sectional view taken along line XIII-XIII of FIG. 10.

FIG. 14 is a schematic sectional view illustrating a configuration of one end portion of a liquid droplet discharge head according to a variation of the second embodiment.

### DESCRIPTION OF EMBODIMENTS

In the following, embodiments for implementing a liquid droplet discharge head and a droplet discharge apparatus according to the present disclosure (hereinafter referred to as “embodiments”) are elaborated with reference to the accompanying drawings. It should be noted that the present disclosure is not limited to this embodiment. Furthermore, each embodiment may be appropriately combined as long as the processing content does not contradict each other. In addition, in the following embodiments, the same reference numerals are assigned to identical components, and redundant descriptions are omitted.

In the embodiments described below, terms such as “constant,” “orthogonal,” “vertical,” or “parallel” may be used. However, these terms do not necessarily mean strictly “constant,” “orthogonal,” “vertical,” or “parallel.” That is, these expressions allow for deviations due to, for example, manufacturing precision or installation accuracy.

Additionally, in the drawings referenced below, to facilitate understanding, an orthogonal coordinate system may be defined, in which the X-axis direction, Y-axis direction, and Z-axis direction are mutually orthogonal, and the positive Z-axis direction is set as the vertically upward direction. Furthermore, in some cases, the rotational direction about the vertical axis may be referred to as the θ direction.

In the related art, as a printing head, a liquid discharging head that performs various printing by discharging liquid onto a recording medium is known, for example. Patent Document 1 discloses an ink-jet head including a planar laminated flow channel unit including an ink channel that guides to the ink outlet the ink supplied from the ink supply port.

However, a liquid droplet discharge head including a channel unit composed of a stack of a plurality of flat plates, as disclosed in Patent Document 1, still has room for further improvement in terms of increasing rigidity. If the rigidity of the liquid droplet discharge head is low, there is a risk that, for example, the amount of deflection of the nozzle surface may become large, thus leading to discharging defects or a reduction in printing accuracy.

In view of this, a technique for increasing the rigidity of the liquid droplet discharge head has been desired.

### First Embodiment

### Configuration of Printer

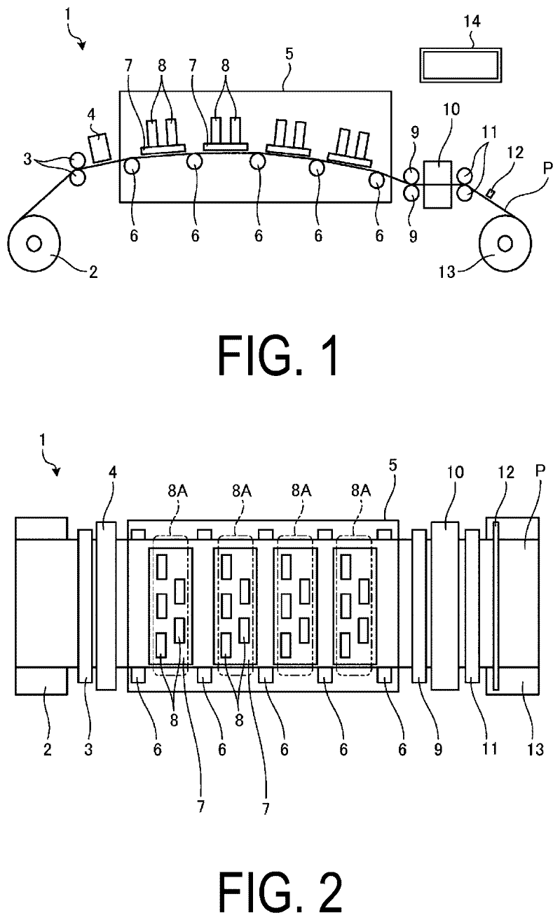

First, an overview of a printer 1, which is an example of a recording apparatus according to the first embodiment, is described with reference to FIGS. 1 and 2. FIG. 1 is a schematic side view of the printer 1 according to the first embodiment, and FIG. 2 is a schematic plan view of the printer 1 according to the first embodiment. The printer 1 according to the first embodiment is, for example, a color ink-jet printer.

As illustrated in FIG. 1, the printer 1 includes a paper feed roller 2, a guide roller 3, an applier 4, a head case 5, a plurality of transport rollers 6, a plurality of frames 7, a plurality of liquid droplet discharge heads 8, a transport roller 9, a drier 10, a transport roller 11, a sensor section 12, and a collection roller 13.

Further, the printer 1 includes a controller 14 that controls the paper feed roller 2, the guide roller 3, the applier 4, the head case 5, the plurality of transport rollers 6, the plurality of frames 7, the plurality of liquid droplet discharge heads 8, the transport roller 9, the drier 10, the transport roller 11, the sensor section 12 and the collection roller 13.

The printer 1 performs recording of images or letters on a printing sheet P by depositing droplets on the printing sheet P. The printing sheet P is an example of the recording medium. The printing sheet P is wound around the paper feed roller 2 before use. The printer 1 transports the printing sheet P from the paper feed roller 2 to the inside of the head case 5 through the guide roller 3 and the applier 4.

The applier 4 uniformly applies the coating agent to the printing sheet P. In this manner, a surface treatment can be provided on the printing sheet P, and the printing quality of the printer 1 can be improved.

The head case 5 houses the plurality of transport rollers 6, the plurality of frames 7, and the plurality of liquid droplet discharge heads 8. The interior of the head case 5 forms a space isolated from the outside, except in some parts connected to the outside such as the part where the printing sheet P enters and leaves the case.

At least one of control factors such as temperature, humidity, and air pressure of the internal space of the head case 5 is controlled as necessary by the controller 14. A transport roller 6 transports the printing sheet P to the vicinity of a liquid droplet discharge head 8 inside the head case 5.

A frame 7 is a rectangular flat plate that is located over and near the printing sheet P transported by the transport roller 6. In addition, as illustrated in FIG. 2, the frame 7 is located such that the longitudinal direction is orthogonal to the transport direction of the printing sheet P. Inside the head case 5, a plurality of (for example, four) frames 7 is located along the transport direction of the printing sheet P.

Note that, in the following description, the transport direction of the printing sheet P is also referred to as “sub-scanning direction”, and the direction orthogonal to the sub-scanning direction and parallel to the printing sheet P is a part referred to as “the main scanning direction”.

Liquid such as ink is supplied to the liquid droplet discharge head 8 from a liquid tank not illustrated in the drawing. The liquid droplet discharge head 8 discharges droplets supplied from the liquid tank.

The controller 14 controls the liquid droplet discharge head 8 based on data on images or letters to discharge droplets toward the printing sheet P. The distance between the liquid droplet discharge head 8 and the printing sheet P is, for example, about 0.5 to 20 mm.

The liquid droplet discharge head 8 is fixed to the frame 7. The liquid droplet discharge head 8 is fixed to the frame 7 at both end portions in the longitudinal direction, for example. The liquid droplet discharge head 8 is located such that the longitudinal direction is orthogonal to the transport direction of the printing sheet P.

Specifically, the printer 1 according to the first embodiment is a so-called line printer in which the liquid droplet discharge head 8 is fixed inside the printer 1. Note that, the printer 1 according to the first embodiment is not limited to a line printer, but may be a so-called serial printer. A serial printer is a printer that alternately performs the transport of the printing sheet P, and the recording operation that is performed while moving the liquid droplet discharge head 8 in the direction that intersects the transport direction of the printing sheet P such as the direction substantially orthogonal to the transport direction of the printing sheet P.

As illustrated in FIG. 2, a plurality of (for example, five) droplet discharge heads 8 is fixed to one frame 7. FIG. 2 illustrates an example in which three liquid droplet discharge heads 8 are provided on the front side and two liquid droplet discharge heads 8 are provided on the rear side in the transport direction of the printing sheet P, and the liquid droplet discharge heads 8 are located such that the centers of the liquid droplet discharge heads 8 do not overlap in the transport direction of the printing sheet P.

A head group 8A is configured with the plurality of liquid droplet discharge heads 8 located at one frame 7. The four head groups 8A are located along the transport direction of the printing sheet P. Ink of the same color is supplied to the liquid droplet discharge heads 8 belonging to the same head group 8A. In this manner, the printer 1 can perform printing with four colors of ink using the four head groups 8A.

The colors of inks discharged from head group 8A are, for example, magenta (M), yellow (Y), cyan (C) and black (K). The controller 14 can perform printing of a color image on the printing sheet P by controlling each head group 8A to discharge inks of a plurality of colors to the printing sheet P.

Note that, for the purpose of providing surface treatment of the printing sheet P, coating agent may be discharged to the printing sheet P from the liquid droplet discharge head 8.

In addition, the number of liquid droplet discharge heads 8 included in one head group 8A, or the number of the head groups 8A mounted on the printer 1 can be changed according to the object to be printed or the printing conditions. For example, in the case where the color to be printed on the printing sheet P is a single color and the range that can be printed by one liquid droplet discharge head 8 is to be printed, the number of liquid droplet discharge heads 8 mounted on the printer 1 may be one.

The printing sheet P that has been subjected to the printing process inside the head case 5 is transported by the transport roller 9 to the outside of the head case 5 and transported through the inside of the drier 10. The drier 10 dries the printing sheet P that has been subjected to the printing process. The printing sheet P dried by the drier 10 is transported by the transport roller 11 and collected by the collection roller 13.

In the printer 1, drying the printing sheet P with the drier 10 can reduce adhesion of the printing sheet P wound in an overlapping manner, and rubbing of undried liquid at the collection roller 13.

The sensor section 12 is composed of a location sensor, a speed sensor, a temperature sensor or the like. The controller 14 can determine the status of each section of the printer 1 and control each section of the printer 1 on the basis of information from the sensor section 12.

The printer 1 described above uses the printing sheet P as the printing object (i.e., the recording medium), but the printing object in the printer 1 is not limited to the printing sheet P. For example, the printing object may be rolled cloth.

In addition, the printer 1 may transport the printing sheet P on a transport belt instead of directly transporting it. The use of the transport belt enables the printer 1 to perform printing on flat sheets, cut cloth, wood, tiles or the like as printing objects.

In addition, the printer 1 may perform printing of wiring patterns of electronic apparatuses by discharging droplets containing conductive particles from the liquid droplet discharge head 8. In addition, the printer 1 may produce a chemical agent by discharging a predetermined amount of liquid chemical medicine or droplets containing chemical medicine from the liquid droplet discharge head 8 toward a reactor and the like.

In addition, the printer 1 may include a cleaning part for cleaning of the liquid droplet discharge head 8. The cleaning part performs cleaning of the liquid droplet discharge head 8 through a wiping process or a capping process, for example.

The wiping process is a process of removing liquid adhering to the liquid droplet discharge head 8 by wiping the surface of the portion where droplets are discharged with a flexible wiper, for example.

In addition, the capping process is performed as follows, for example. First, the surface of the portion where droplets are discharged is covered with a cap (this is referred to as capping). This forms a substantially sealed space between the cap and the surface of the portion where droplets are discharged.

Next, discharging of droplets in that sealed space is repeated. This can remove liquids of higher viscosity than the standard state, foreign matter or the like that have clogged the discharge hole (nozzle) for discharging droplets.

### Configuration of Liquid Droplet Discharge Head

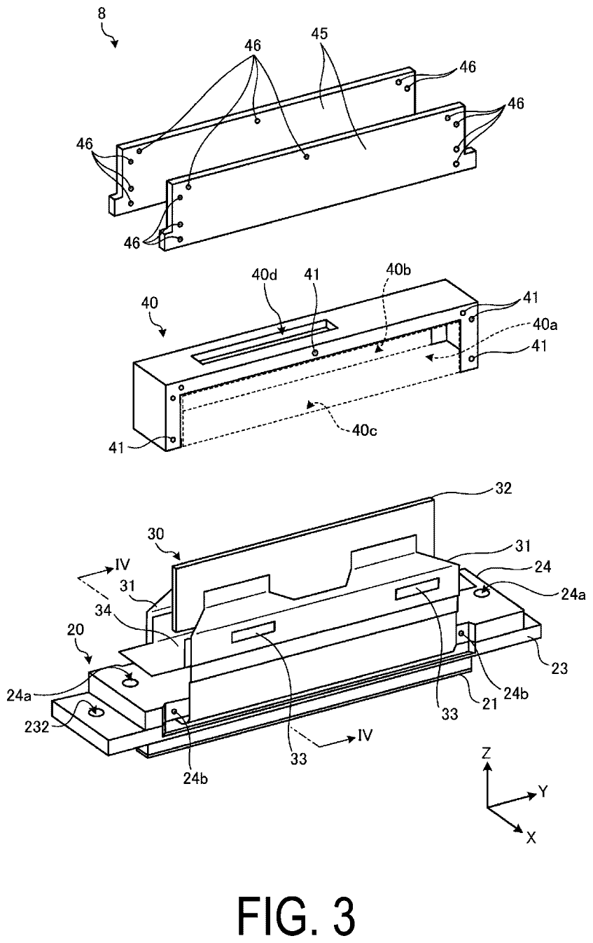

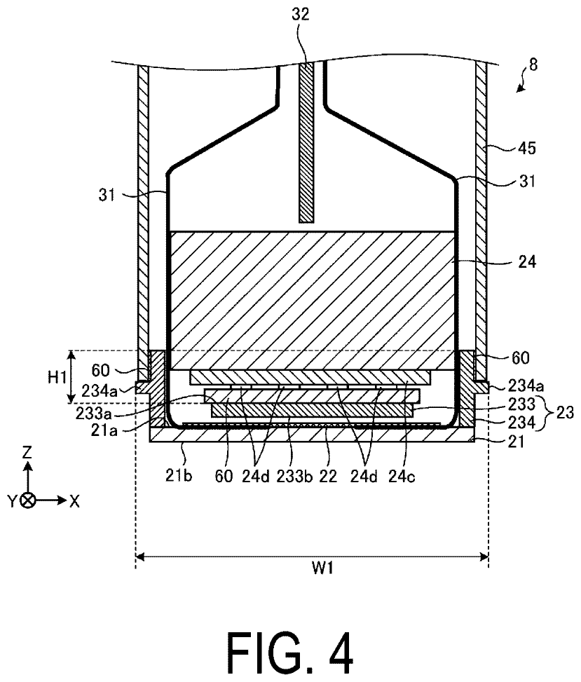

Next, a configuration of the liquid droplet discharge head 8 according to the first embodiment is described with reference to FIGS. 3 and 4. FIG. 3 is an exploded perspective view illustrating a schematic configuration of the liquid droplet discharge head 8 according to the first embodiment. FIG. 4 is an enlarged sectional view taken along line IV-IV of FIG. 3.

The liquid droplet discharge head 8 includes a head main body 20, a wiring portion 30, a head cover 40, and two heat dissipation plates 45. The head main body 20 includes a channel member 21, a piezoelectric actuator substrate 22 (see FIG. 4), a branched channel member 23, and a reservoir 24.

In the following description, for convenience, the direction in which the head main body 20 is provided in the liquid droplet discharge head 8 may be referred to as “lower side”, and the direction in which the head cover 40 is provided to the head main body 20 may be referred to as “upper side”.

The channel member 21 of the head main body 20 has a substantially flat plate shape with a first surface 21a (see FIG. 4) as one main surface, and a second surface 21b (see FIG. 4) located on the side opposite to the first surface. The first surface 21a includes an opening not illustrated in the drawing, and liquid is supplied from the reservoir 24 to the inside of the channel member 21 through the opening.

A plurality of discharge holes (not illustrated in the drawing) for discharge droplets to the printing sheet P is located at the second surface 21b. The channel member 21 includes a channel inside that carries liquid from the first surface 21a to the second surface 21b.

The piezoelectric actuator substrate 22 is located over the first surface 21a of the channel member 21. The piezoelectric actuator substrate 22 includes a plurality of displacement elements (not illustrated in the drawing). A flexible substrate 31 of the wiring portion 30 is electrically connected to the piezoelectric actuator substrate 22.

The branched channel member 23 is located over the channel member 21. The branched channel member 23 includes a branched channel 231 inside (see FIG. 6) that leads to the channel of the channel member 21. The branched channel member 23 is composed of a highly rigid material such as stainless steel, for example. Note that, details of the branched channel member 23 will be described later with reference to FIG. 4.

The reservoir 24 is located over the branched channel member 23. The reservoir 24 is provided with an opening 24a at both end portions in the main scanning direction (Y-axis direction). Specifically, the reservoir 24 includes two openings 24a. The reservoir 24 includes a channel inside, and liquid is supplied from the outside through the opening 24a. The reservoir 24 supplies liquid to the channel member 21. In addition, the reservoir 24 stores the liquid supplied to the channel member 21.

Note that, when performing printing, liquid may be supplied from the opening 24a on one side, with the opening 24a on the other side closed. In addition, liquid may be supplied from the openings 24a on both sides. When initially introducing liquid to the liquid droplet discharge head 8, supplying liquid from the opening 24a on one side and collecting liquid from the opening 24a on the other side allows the air, stored liquid and the like inside the channel in the reservoir 24 to be easily removed, and thus facilitates the introduction of liquid into the liquid droplet discharge head 8.

In addition, during the printing, it is possible to supply liquid from the opening 24a on one side, and collect liquid from the opening 24a on the other side. In this manner, bubbles are less retained inside the channel in the reservoir 24. Further, the temperature of the liquid droplet discharge head 8 can be stabilized by applying liquid adjusted to a constant temperature. The collected liquid may be carried through a filter and the like, and then supplied to the liquid droplet discharge head 8 again. That is, the liquid may be circulated. The supply and collection of liquid at the liquid droplet discharge head 8, or the circulation of liquid may be controlled by the controller 14.

Further, liquid may be supplied from the reservoir 24 to the channel member 21, and liquid may be collected from the channel member 21 to the reservoir 24. Further, in the channel member 21, supply and collection of liquid may be performed for the channel to which the nozzle (discharge hole) faces, to make it difficult for liquid to stay in and around the nozzle. In such a manner, overall, liquid is supplied to the liquid droplet discharge head 8 from the outside, some of the liquid is discharged from the discharge hole, and the liquid that is not discharged is collected outside.

As illustrated in FIG. 4, the reservoir 24 may further include a heater substrate 24c and a heat generating resistor 24d. The heater substrate 24c brings the temperature of the liquid flowing through the head main body 20 closer to a predetermined temperature. In addition, a hole 24b for housing a fixing member 50 (see FIG. 8) is formed in the side surface that faces the heat dissipation plate 45 in the reservoir 24.

The wiring portion 30 includes the flexible substrate 31, a wiring board 32, a plurality of driver ICs 33, and a pressing member 34. The flexible substrate 31 is a flexible wiring board, and transmits to the head main body 20 a predetermined signal sent from the outside. Note that, as illustrated in FIG. 3, the liquid droplet discharge head 8 according to the first embodiment includes two flexible substrates 31.

One end portion of the flexible substrate 31 is electrically connected to the piezoelectric actuator substrate 22 of the head main body 20 (see FIG. 4). The other end portion of the flexible substrate 31 is drawn farther upward than the reservoir 24, and is electrically connected to the wiring board 32. In this manner, the piezoelectric actuator substrate 22 of the head main body 20 and the outside can be electrically connected.

The wiring board 32 is located over the head main body 20. The wiring board 32 distributes signals to the plurality of driver ICs 33.

The plurality of driver ICs 33 is located at one main surface of the flexible substrate 31. As illustrated in FIG. 3, in the liquid droplet discharge head 8 according to the first embodiment, two drivers IC 33 are provided for each flexible substrate 31. Note that, the number of drivers IC 33 provided in each flexible substrate 31 may not be two.

The driver IC 33 drives each displacement element in the piezoelectric actuator substrate 22 of the head main body 20 based on a driving signal sent from the controller 14 (see FIG. 1). In this manner, the driver IC 33 drives the liquid droplet discharge head 8.

The pressing member 34 is a leaf spring with a substantially U-shape in cross-sectional view. The pressing member 34, located between the two flexible substrates 31, presses the driver IC 33 on the flexible substrate 31 toward the heat dissipation plate 45. In this manner, the driver IC makes intimate contact with the heat dissipation plate 45, and thus the heat generated when the driver IC 33 is driven can be efficiently dissipated to the heat dissipation plate 45.

The head cover 40 is attached to the head main body 20, and is disposed to cover the wiring portion 30 located on the head main body 20 such as the flexible substrate 31, the wiring board 32, the pressing member 34 and the like. In this manner, the head cover 40 can seal the wiring portion 30. The head cover 40 is composed of a resin, a metal or the like, for example.

The head cover 40 has a box shape extending long in the main scanning direction, and includes a first opening 40a and a second opening 40b at two opposing side surfaces along the sub-scanning direction. In the example of FIG. 3, the first opening 40a is provided at the side surface located on the positive X axis direction side, and the second opening 40b is provided at the side surface located on the negative X axis direction side. In addition, the head cover 40 includes a third opening 40c at the bottom surface, and a fourth opening 40d at the top surface.

The two heat dissipation plates 45 are attached to the head cover 40. One of the two heat dissipation plates 45 is disposed to close the first opening 40a, while the other is disposed to close the second opening 40b.

The heat dissipation plate 45 is a plate-shaped member that is long in the longitudinal direction of the liquid droplet discharge head 8, and is composed of metals, alloys or the like with high heat dissipation properties, for example. The heat dissipation plate 45 is provided in contact with the driver IC 33, and dissipates the heat generated at the driver IC 33.

Each of the two heat dissipation plates 45 includes a plurality of through holes 46 for housing the fixing member 50 (see FIG. 8). The head cover 40 includes a plurality of through holes 41 for housing the fixing member 50. The two heat dissipation plates 45 are each fixed to the head cover 40 by the fixing member 50 (see FIG. 8). The head cover 40 on which the heat dissipation plate 45 is attached has a box shape with the first opening 40a and the second opening 40b closed and the third opening 40c and the fourth opening 40d opened.

The third opening 40c is located to face the reservoir 24. The flexible substrate 31 and the pressing member 34 are inserted in the third opening 40c.

The fourth opening 40d is provided for insertion of a connector (not illustrated in the drawing) provided in the wiring board 32. When the part between that connector and the fourth opening 40d is sealed with a resin or the like, liquid, foreign matters and the like are less likely to enter the inside of the head cover 40.

In addition, the head cover 40 may include a heat insulating part (not illustrated in the drawing) between the heat dissipation plate 45 and the head main body 20. With the head cover 40 provided with the heat insulating part, the heat generated at the driver IC 33 is less likely to be transmitted to the head main body 20 through the heat dissipation plate 45.

Note that, FIG. 3 illustrates an exemplary configuration of the liquid droplet discharge head 8, and members other than the members illustrated in FIG. 3 may be further provided.

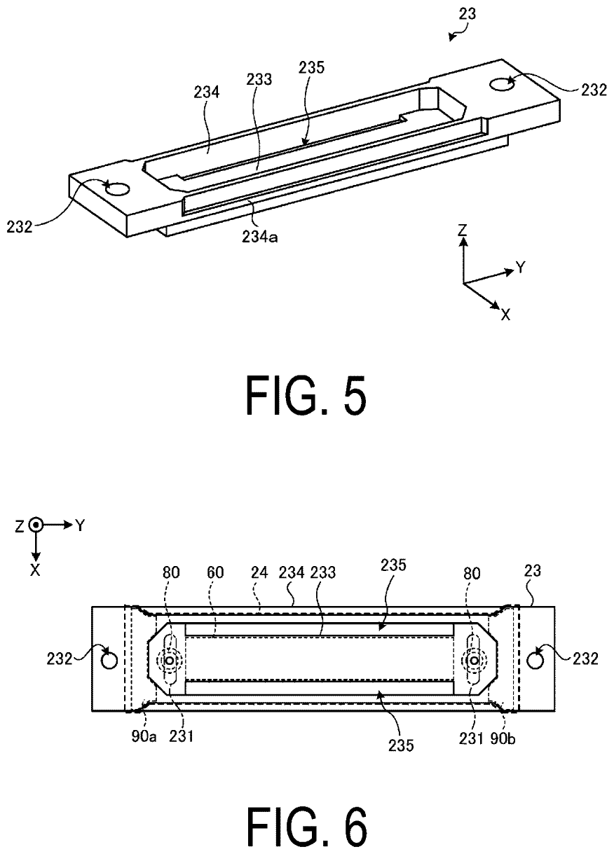

Next, details of the branched channel member 23 according to the first embodiment are described with reference to FIGS. 5 and 6. FIG. 5 is a perspective view for describing a structure of the branched channel member 23 according to the first embodiment. FIG. 6 is a schematic plan view of the branched channel member 23 according to the first embodiment.

As illustrated in FIG. 5, the branched channel member 23 is a member having a box shape extending long in the main scanning direction (Y-axis direction), with the top surface opened. The branched channel member 23 includes a bottom 233, a peripheral wall 234 provided upright from the bottom 233, and two slit parts 235. The bottom 233 is located over the channel member 21. The bottom 233 includes an opposing surface 233a facing the channel member 21, and a box bottom surface 233b located opposite to the opposing surface 233a (see FIG. 4). The box bottom surface 233b is surrounded by the peripheral wall 234.

The branched channel member 23 has a box shape, and thus the rigidity of the branched channel member 23 can be increased in comparison with the case where the branched channel member 23 has a flat plate shape. In this manner, the deflection of the nozzle surface of the channel member 21 joined to the branched channel member 23 can be reduced.

In the branched channel member 23 according to the first embodiment, a height H1 of the peripheral wall 234 (see FIG. 4) with respect to the box bottom surface 233b is greater than 20% of a width W1 (see FIG. 4) of the bottom 233 in the short direction. In this manner, the rigidity of the branched channel member 23 can be further increased.

The peripheral wall 234 of the branched channel member 23 further includes an eave 234a protruding outward of the branched channel member 23. In this manner, it is possible to prevent the droplet discharged from the discharge hole of the channel member 21 from scattering to the heat dissipation plate 45, fixing materials 70a to 70d described later and the like.

A part of the reservoir 24 is located in a region surrounded by the peripheral wall 234 and the bottom 233 of the branched channel member 23. In other words, a part of the reservoir 24 is housed inside the branched channel member 23 with a box shape. In this manner, in comparison with the case where the reservoir 24 is provided above the branched channel member 23 with a flat plate shape, the liquid droplet discharge head 8 can be downsized in the height direction (Z-axis direction).

The slit part 235 is a void with a groove shape extending along the longitudinal direction (Y-axis direction) of the branched channel member 23. The two slit parts 235 are provided with the bottom 233 sandwiched therebetween in plan view. The flexible substrate 31 connected to the piezoelectric actuator substrate 22 is inserted to the slit part 235.

In the first embodiment, an elastic member 60 is located between the branched channel member 23 and the reservoir 24. The elastic member 60 is a plate-shaped member extending long in the longitudinal direction of the liquid droplet discharge head 8 (Y-axis direction) in plan view, and is located over the bottom 233 of the branched channel member 23 (see FIG. 4). Silicone rubber may be used as the elastic member 60, for example. The elastic member 60 may have a higher thermal conductivity than the branched channel member 23. In this manner, the heat of the heater substrate 24c of the reservoir 24 is efficiently transmitted to the branched channel member 23, and the temperature distribution of the nozzle surface can be brought closer to a uniform distribution.

In the first embodiment, a plurality of O-rings 80 that seals the connecting portion of the branched channel member 23 and the reservoir 24 is located between the branched channel member 23 and the reservoir 24. In this manner, the sealing property of the liquid droplet discharge head 8 can be further increased.

In addition, in the liquid droplet discharge head 8 according to the first embodiment, even when the stress is generated due to the provision of the elastic member 60 and the O-ring 80, the deflection of the nozzle surface of the channel member 21 joined to the branched channel member 23 can be reduced since the rigidity of the branched channel member 23 is high.

In the first embodiment, the branched channel member 23 and the reservoir 24 are fixed at both end portions of the liquid droplet discharge head 8 in the longitudinal direction. For example, as illustrated in FIG. 6, the branched channel member 23 and the reservoir 24 are fixed by fixing materials 90a and 90b (an example of the first fixing material). The fixing materials 90a and 90b are waterproof double-sided tapes, for example. Note that, this is not limitative, and gel, sealing resin or the like may be used as the fixing materials 90a and 90b. In this manner, the sealing property of the branched channel member 23 and the reservoir 24 can be increased, thus preventing liquid from flowing out.

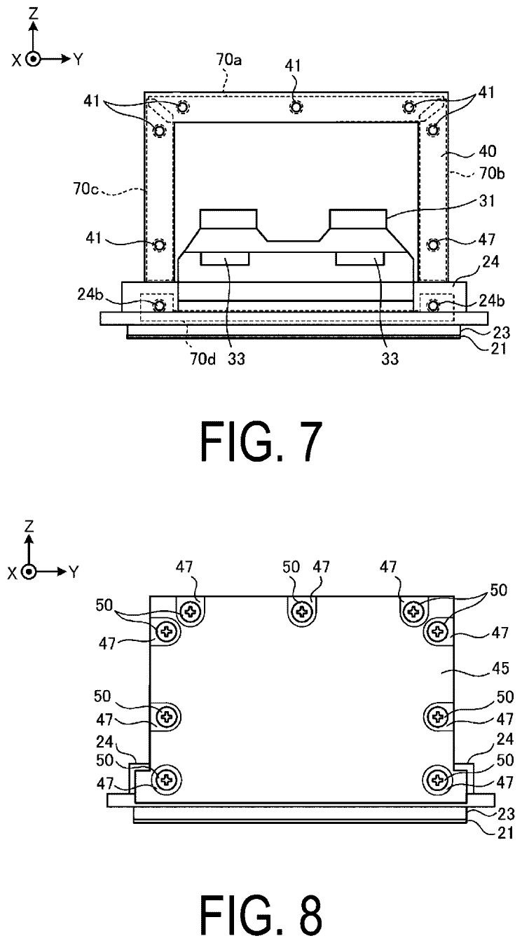

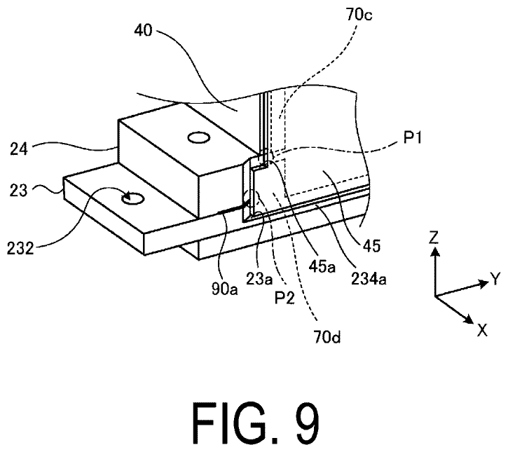

Next, details of the fixing portion of the heat dissipation plate 45, the branched channel member 23 and the reservoir 24 described above are described with reference to FIGS. 7 to 9. FIGS. 7 and 8 are schematic front views of the liquid droplet discharge head 8 according to the first embodiment. FIG. 9 is an enlarged perspective view of the liquid droplet discharge head 8 according to the first embodiment. Note that, for convenience of description, the heat dissipation plate 45 and the fixing member 50 are omitted in FIG. 7. In addition, a recess 47 of the heat dissipation plate 45 and the fixing member 50 are omitted in FIG. 9.

As illustrated in FIGS. 7 and 8, in the first embodiment, the heat dissipation plate 45, and the branched channel member 23 and the reservoir 24 are fixed with a fixing material 70d (an example of the second fixing material). For example, a double-sided tape, gel, a sealing resin may be used as the fixing material 70d. In the case where the fixing material 70d is a waterproof double-sided tape, one adhesive surface of the fixing material 70d is located across the branched channel member 23 and the reservoir 24, and the other adhesive surface is located at the heat dissipation plate 45. In this manner, the sealing property of the liquid droplet discharge head 8 can be further increased, and leakage of liquid less occurs.

In addition, in the first embodiment, the head cover 40 and the heat dissipation plate 45 may be fixed with fixing materials 70a to 70c (an example of the third fixing material). A waterproof double-sided tape, gel, a sealing resin may be used for the fixing materials 70a to 70c similarly to the fixing material 70c. In the case where the fixing materials 70a to 70c are waterproof double-sided tapes, one adhesive surface of the fixing materials 70a to 70c is located at the flanges (where a through hole 41 is provided) located at the periphery of the first opening 40a and the second opening 40b (FIG. 3) of the head cover 40, and the other adhesive surface is located at the heat dissipation plate 45. In this manner, the sealing property of the liquid droplet discharge head 8 can be further increased.

In addition, in the first embodiment, the reservoir 24 and the head cover 40 and the heat dissipation plate 45 are partially sealed with a caulking material. More specifically, as illustrated in FIG. 9, the liquid droplet discharge head 8 includes a region P1 where both the fixing material 70c and the fixing material 70d are not present in a part of the gap between the reservoir 24 and the head cover 40 and the heat dissipation plate 45. The caulking material is located in the region P1. Specifically, the caulking material is located across the reservoir 24 and the heat dissipation plate 45 to seal the gap between the reservoir 24 and the heat dissipation plate 45 where both the fixing material 70c and the fixing material 70d are not present. Resin may be used as the caulking material, for example. In this manner, the reservoir 24 and the heat dissipation plate 45 may be fixed even between adjacent fixing materials, and thus the sealing property of the liquid droplet discharge head 8 can be further increased.

As illustrated in FIG. 8, in the heat dissipation plate 45, the portion facing the branched channel member 23 and the reservoir 24 protrudes farther in the longitudinal direction (Y-axis direction) of the head main body 20 than the portion facing the head cover 40. A top surface 45a in the portion facing the branched channel member 23 and the reservoir 24 is located at a lower portion of the above-described region P1. In this manner, at the time of manufacture of the liquid droplet discharge head 8, for example, even when the uncured caulking material applied to the region P1 drops due to gravity, this caulking material can be received by the top surface 45a, and thus the region P1 can be more reliably sealed with the caulking material.

In addition, the branched channel member 23 and the reservoir 24 and the heat dissipation plate 45 are partially sealed with a caulking material. More specifically, as illustrated in FIG. 9, the liquid droplet discharge head 8 includes a region P2 where the fixing material 90a and the fixing material 70d make contact with each other in a part of the gap between the branched channel member 23 and the reservoir 24 and the heat dissipation plate 45. The caulking material is located in the region P2. In the region P2, the side surface (that is not an adhesive surface) of the fixing material 90a makes contact with the fixing material 70d, which may make the sealing insufficient. Thus, by sealing the part between the fixing material 90a and the fixing material 70d with the caulking material, the sealing property of the liquid droplet discharge head 8 can be further increased. In this manner, even at the part where fixing materials make perpendicular contact with each other, the branched channel member 23 and the reservoir 24, and the heat dissipation plate 45 can be fixed, and thus the sealing property of the liquid droplet discharge head 8 can be further increased.

As illustrated in FIG. 8, a top surface 23a of the eave 234a of the branched channel member 23 is located below the above-described region P2. In this manner, at the time of manufacture of the liquid droplet discharge head 8, for example, even when the uncured caulking material applied to the region P2 drops due to gravity, this caulking material can be received by the top surface 23a, and thus the region P2 can be more reliably sealed with the caulking material.

In the first embodiment, the reservoir 24 and the heat dissipation plate 45 are fixed by the fixing member 50. More specifically, the reservoir 24 and the heat dissipation plate 45 are fixed by the fixing member 50 at both end portions of the liquid droplet discharge head 8 in the longitudinal direction. The fixing member 50 includes a shaft portion provided with spiral groove at the outer periphery, and a head located at the end portion of the shaft portion. As the fixing member 50, a screw, a bolt or a screw may be used, for example. In this manner, the region around the part fixed with the caulking material and the fixing materials 70a to 70d can be fixed, and thus the sealing property of the liquid droplet discharge head 8 can be further increased.

In addition, in the first embodiment, the heat dissipation plate 45 includes a plurality of recesses 47 for housing the head of the fixing member 50. In this manner, in comparison with the case where the recess 47 is not provided, the protruding amount of the fixing member 50 can be reduced, and thus the liquid droplet discharge head 8 can be downsized in the short direction.

### Second Embodiment

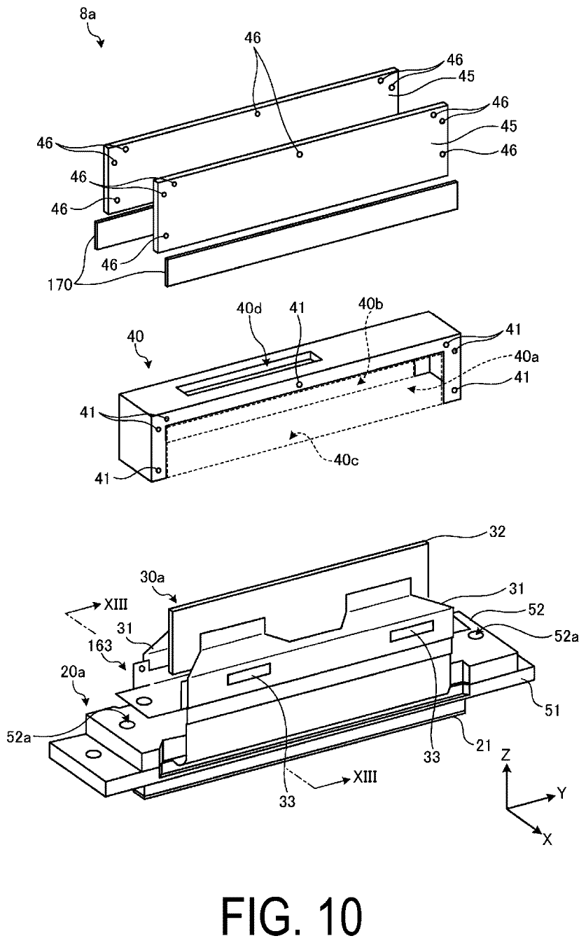

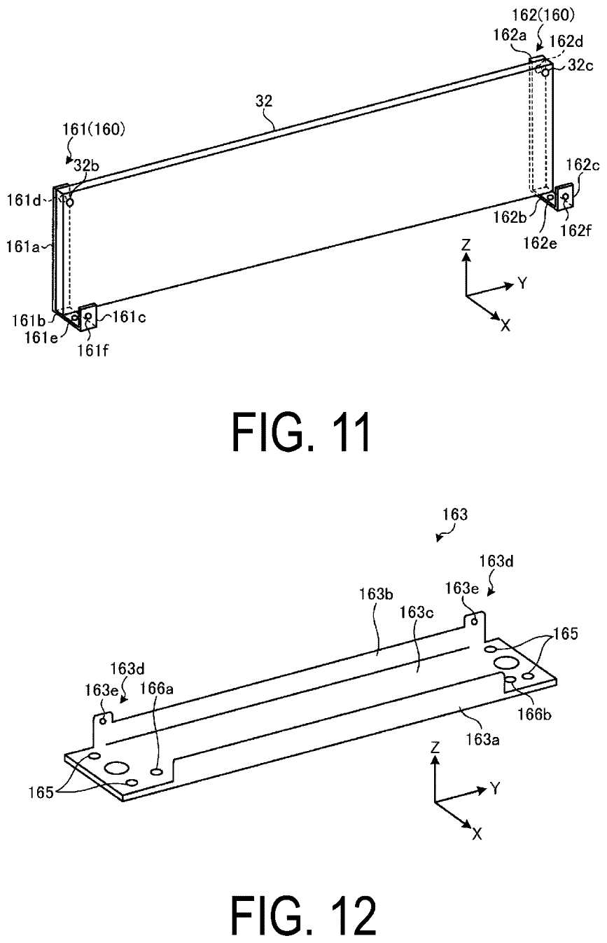

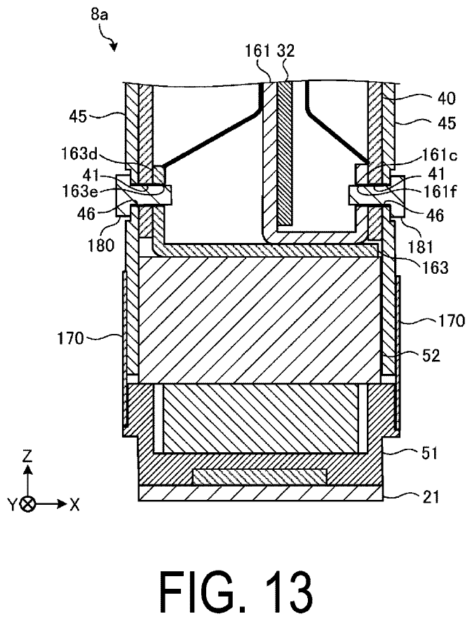

Next, a liquid droplet discharge head 8a according to the second embodiment is described with reference to FIGS. 10 to 13. FIG. 10 is an exploded perspective view illustrating a schematic configuration of the liquid droplet discharge head 8a according to a second embodiment. FIG. 11 is a schematic perspective view illustrating configurations of the wiring board 32, a first supporting member 161 and a second supporting member 162 according to the second embodiment. FIG. 12 is a schematic perspective view illustrating a configuration of a pressing member 163 according to the second embodiment. FIG. 13 is a sectional view taken along line XIII-XIII of FIG. 10. In other words, FIG. 13 is a sectional view of one end portion of the head main body 20 in the longitudinal direction. Note that, for convenience of description, a supporting member 160 is omitted in FIG. 10. In addition, in the second embodiment described below, the same components as those of the first embodiment are denoted with the same reference symbols and overlapping description will be omitted.

The liquid droplet discharge head 8a illustrated in FIG. 10 differs from the liquid droplet discharge head 8 according to the first embodiment illustrated in FIG. 3 mainly in the configuration of the wiring portion 30 and the like.

As with the liquid droplet discharge head 8 according to the first embodiment illustrated in FIG. 3, the liquid droplet discharge head 8a according to the second embodiment includes the head main body 20a, the wiring portion 30a, the head cover 40, and the two heat dissipation plates 45.

The head main body 20a includes the channel member 21, a piezoelectric actuator substrate (not illustrated in the drawing), a branched channel member 51, and a reservoir 52.

The wiring portion 30a includes the flexible substrate 31, the wiring board 32, a plurality of supporting members 160, the plurality of driver ICs 33, and the pressing member 163.

As illustrated in FIG. 11, the plurality of supporting members 160 supports the wiring board 32. More specifically, the plurality of supporting members 160 includes the first supporting member 161, and the second supporting member 162.

The first supporting member 161 is located at one end portion of the wiring board 32 in the longitudinal direction of the head main body 20a. More specifically, the first supporting member 161 includes a base part 161b, a supporting part 161 a perpendicularly extending from one end of the base part 161b in the longitudinal direction, and a fixer 161c perpendicularly extending from the other end of the base part 161b in the longitudinal direction. The wiring board 32 is set with the bottom surface located over the base part 161b, and one main surface located in contact with the supporting part 161a.

A through hole 161d is formed in the supporting part 161a. The wiring board 32 includes a through hole 32b extending through both main surfaces at a position corresponding to the through hole 161d. A fixing member such as a screw and a bolt (not illustrated in the drawing) is inserted to the through hole 161d and through hole 32b, and threadedly engaged, and thus the wiring board 32 and the first supporting member 161 are fixed. A through hole 161e is formed in the base part 161b. The fixer 161c is elaborated later.

The second supporting member 162 is located at the other end portion of the wiring board 32 in the longitudinal direction of the head main body 20a. More specifically, the second supporting member 162 includes a base part 162b, a supporting part 162a perpendicularly extending from one end of the base part 162b in the longitudinal direction, and a fixer 162c perpendicularly extending from the other end of the base part 162b in the longitudinal direction. The wiring board 32 is set with the bottom surface located over the base part 162b, and one main surface located in contact with the supporting part 162a.

A through hole 162d is formed in the supporting part 162a. The wiring board 32 includes a through hole 32b extending through both main surfaces at a position corresponding to the through hole 161d. A fixing member such as a screw and a bolt (not illustrated in the drawing) is inserted to the through hole 161d and through hole 32b, and threadedly engaged, and thus the wiring board 32 and the second supporting member 162 are fixed. A through hole 162e is formed in the base part 162b. The fixer 162c is elaborated later.

As illustrated in FIG. 12, the pressing member 163 includes two side wall parts 163a and 163b, a bottom 163c, and two fixers 163d.

The bottom 163c couples the lower ends of the two side wall parts 163a and 163b. The bottom 163c includes a plurality of through holes 165 at both end portions of the head main body 20 in the longitudinal direction. In the reservoir 52, a through hole (not illustrated in the drawing) is located at a position corresponding to the through hole 165. In the branched channel member 51, a screw hole (not illustrated in the drawing) is located at a position corresponding to the through hole 165. A fixing member such as a bolt or a screw (not illustrated in the drawing) is inserted to the through hole 165 of the bottom 163c of the pressing member 163, and the through hole of the reservoir 52. The fixing member not illustrated in the drawing is threadedly engaged with a screw hole of the branched channel member 51. In this manner, through the reservoir 52, the pressing member 163 is fixed to the branched channel member 51 composed of a highly rigid material.

In addition, in the bottom 163c, a through hole 166a is formed at a position corresponding to the through hole 161e (see FIG. 11) in the base part 161b of the first supporting member 161. A fixing member such as a bolt or a screw (not illustrated in the drawing) is inserted to the through hole 166a and the through hole 161e. The fixing member not illustrated in the drawing is threadedly engaged with a screw groove formed in the through hole 161e, for example. In this manner, the first supporting member 161 is fixed to the pressing member 163. Likewise, in the bottom 163c, a through hole 166b is formed at a position corresponding to the through hole 162e of the base part 162b of the second supporting member 162. A fixing member such as a bolt or a screw (not illustrated in the drawing) is inserted to the through hole 166b and the through hole 162e. The fixing member not illustrated in the drawing is threadedly engaged with a screw groove formed in the through hole 162e, for example. In this manner, the second supporting member 162 is fixed to the pressing member 163. In this manner, the first supporting member 161 is fixed to the pressing member 163, and fixed to the branched channel member 51 composed of a highly rigid material through the pressing member 163 and the reservoir 52.

The two fixers 163d are provided at both end portions of one of the two side wall parts 163a and 163b (here, the side wall part 163b). In other words, the two fixers 163d are provided at both end portions of the pressing member 163 in the longitudinal direction of the head main body 20. The fixer 163d is elaborated later.

As described above, the pressing member 163 and the plurality of supporting members 160 according to the second embodiment are fixed to the branched channel member 51 composed of a highly rigid material. Further, the heat dissipation plate 45 according to the second embodiment is fixed to the pressing member 163 and the plurality of supporting members 160 at both end portions of the head main body 20 in the longitudinal direction.

With the liquid droplet discharge head 8a with such a configuration, the head cover 40 is less likely to collapse even when an external force is applied to the heat dissipation plate 45.

In the following, details of the fixing portion of the head cover 40 and the pressing member 163 and the plurality of supporting members 160 are described with reference to FIG. 13. Note that, FIG. 13 illustrates a configuration of the fixing portion of one end portion of the liquid droplet discharge head 8a in the longitudinal direction and omits the illustration of the configuration of the fixing portion of the other end portion, but the fixing portion of the other end portion has the same configuration as that of the fixing portion of one end portion.

First, a fixing portion on one end side of the liquid droplet discharge head 8a in the width direction, more specifically the negative X axis direction side, is described. A through hole 163e is formed in the fixer 163d of the pressing member 163. In the head cover 40, the through hole 41 is located at a position corresponding to the through hole 163e. In one of the two heat dissipation plates 45, the through hole 46 is located at a position corresponding to the through hole 163e. When a fixing member 180 is inserted to the through hole 163e, the through hole 41, and the through hole 46, and threadedly engaged, the pressing member 163, the head cover 40 and the heat dissipation plate 45 are fixed at one end portion of the head main body 20 in the longitudinal direction.

Next, a fixing portion on the other end side of the liquid droplet discharge head 8a in the width direction, more specifically the positive X axis direction side, is described. A through hole 161f is formed in the fixer 161c of the first supporting member 161. In the head cover 40, the through hole 41 is located at a position corresponding to the through hole 161f. In the other of the two heat dissipation plates 45, the through hole 46 is located at a position corresponding to the through hole 161f. When a fixing member 181 is inserted to the through hole 161f, the through hole 41, and the through hole 46, and threadedly engaged, the first supporting member 161, the head cover 40 and the heat dissipation plate 45 are fixed at one end portion of the head main body 20 in the longitudinal direction.

Likewise, at the other end portion of the head main body 20 in the longitudinal direction, the pressing member 163 or the second supporting member 162, and the head cover 40, and, the heat dissipation plate 45 are fixed with the fixing member. In this manner, the heat dissipation plate 45 and the head cover 40 according to the second embodiment are fixed to a member directly or indirectly fixed to the branched channel member 51 (here, the pressing member 163, the first supporting member 161 and the second supporting member 162) at both end portions of the head main body 20 in the longitudinal direction. In this manner, the head cover 40 is less likely to collapse even when an external force is applied to the liquid droplet discharge head 8a. If the head cover 40 collapses, the resin sealing between the head cover 40 and the reservoir 52 may be peeled off. In contrast, according to the liquid droplet discharge head 8a according to the second embodiment, the head cover 40 is less likely to collapse and the sealing is less likely to break.

In the liquid droplet discharge head 8a according to the second embodiment, the branched channel member 51 may have a box shape as in the liquid droplet discharge head 8 according to the first embodiment. In this manner, in comparison with the case where the branched channel member 51 has a flat plate shape, the rigidity of the branched channel member 51 can be increased. In this manner, the deflection of the nozzle surface of the channel member 21 joined to the branched channel member 51 can be reduced.

The liquid droplet discharge head 8a according to the second embodiment may further include two plate members 170 that join the heat dissipation plate 45 and the head main body 20.

The plate member 170 is made of resin, and joins the heat dissipation plate 45 and the branched channel member 51 of the head main body 20. The plate member 170 is a member extending long in the main scanning direction (Y-axis direction). The width of the plate member 170 in the longitudinal direction is approximately equal to the width of the heat dissipation plate 45 in the longitudinal direction. The thermal conductivity of the plate member 170 may be lower than the thermal conductivity of the heat dissipation plate 45. With the plate member 170, the heat generated at the driver IC 33 is less likely to be transmitted to the head main body 20 through the heat dissipation plate 45.

The plate member 170, and the heat dissipation plate 45 and the branched channel member 51 of the head main body 20 may be bonded with a double-sided tape or adhesive.

As described above, the liquid droplet discharge head 8a according to the second embodiment is fixed to a member directly or indirectly fixed to the branched channel member 51 and the heat dissipation plate 45 at both end portions of the head main body 20 in the longitudinal direction. In this manner, the rigidity of the liquid droplet discharge head 8a can be increased.

Note that, an example in which the member fixed to the heat dissipation plate 45 at both end portions of the head main body 20 in the longitudinal direction is the pressing member 163 and the supporting member 160 is described above, but that member needs only to be a member directly or indirectly fixed to at least the branched channel member 51, and may not be the pressing member 163 and the supporting member 160. For example, the member fixed to the heat dissipation plate 45 at both end portions of the head main body 20 in the longitudinal direction may be only the pressing member 163. In this case, the fixer 163d may be provided at both two side wall parts 163a and 163b (see FIG. 12) of the pressing member 163. In addition, the member fixed to the heat dissipation plate 45 at both end portions of the head main body 20 in the longitudinal direction may be only the supporting member 160, or may be another member.

### Variation of Second Embodiment

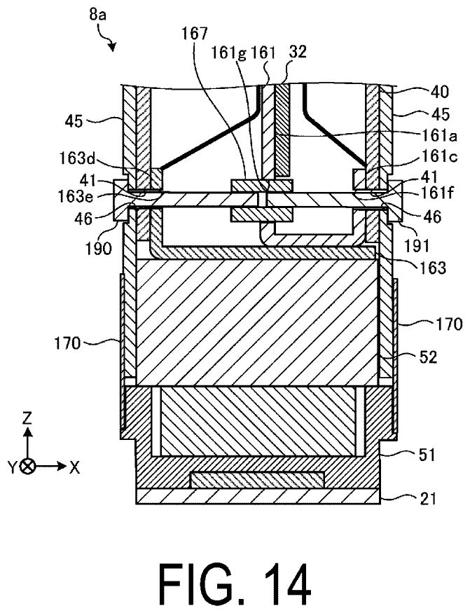

A variation of the liquid droplet discharge head 8a according to the second embodiment is described below with reference to FIG. 14. FIG. 14 is a schematic sectional view illustrating a configuration of one end portion of the liquid droplet discharge head 8a according to a variation of the second embodiment. Note that, in the variation described below, the same components as those of the second embodiment are denoted with the same reference symbols and overlapping description will be omitted.

The fixing member for fixing the heat dissipation plate 45 to the pressing member 163 and the fixing member for fixing the heat dissipation plate 45 to the supporting member 160 may be fastened to the same member.

More specifically, as illustrated in FIG. 14, the first supporting member 161 may include a cylinder 167 in which a screw groove is formed in the inner peripheral surface. The cylinder 167 has a cylindrical shape, for example. For example, the cylinder 167 may be inserted to a notch 161g provided in the supporting part 161a of the first supporting member 161. In addition, the cylinder 167 may be formed integrally with the first supporting member 161. A first male screw 190 is inserted to the through hole 46 of one of the two heat dissipation plates 45, the through hole 41 of the head cover 40, and the through hole 163e of the fixer 163d of the pressing member 163. The first male screw 190 is threadedly engaged with the cylinder 167. In this manner, one of the two heat dissipation plates 45, and the head cover 40 and the pressing member 163 are fixed at one end portion of the head main body 20 in the longitudinal direction.

Likewise, a second male screw 191 is inserted to the other of the two heat dissipation plates 45, the through hole 46, the through hole 41 of the head cover 40, the through hole 161e of the fixer 161c of the first supporting member 161. The second male screw 191 is threadedly engaged with the cylinder 167, and thus the other of the two heat dissipation plates 45, and the head cover 40 and the first supporting member 161 are fixed at one end portion of the head main body 20 in the longitudinal direction.

Likewise, at the other end portion of the head main body 20 in the longitudinal direction, the second supporting member 162 has a cylinder (not illustrated in the drawing) in which a screw groove is formed in the inner peripheral surface, and a first male screw (not illustrated in the drawing) for fixing one of the two heat dissipation plates 45 and the pressing member 163 and a second male screw (not illustrated in the drawing) for fixing the other of the two heat dissipation plates 45 and the second supporting member 162 may be fastened to the same cylinder.

In this manner, according to the liquid droplet discharge head 8a according to the second embodiment, with the first male screw 190 and the second male screw 191 fastened to the same cylinder 167, the rigidity of the liquid droplet discharge head 8a can be further increased.
(1) In an embodiment, a liquid droplet discharge head (e.g., the liquid droplet discharge head 8) includes a channel member (e.g., the channel member 21), a branched channel member (e.g., the branched channel member 23), and a reservoir (e.g., the reservoir 24). The channel member includes a plurality of discharge holes for discharging droplets. The branched channel member is located over the channel member and includes a branched channel (e.g., the branched channel 231) connected to the channel member. The reservoir is located over the branched channel member, and configured to supply liquid to the branched channel member. The branched channel member has a box shape.
(2) In the liquid droplet discharge head according to the above-described (1), the branched channel member may include a bottom (e.g., the bottom 233) located over the channel member, and a peripheral wall (e.g., the peripheral wall 234) provided upright from the bottom, the bottom may include a contact surface that makes contact with the channel member, and a box bottom surface located opposite to the contact surface, and a height of the peripheral wall with respect to the box bottom surface may be greater than 20% of a width of the bottom in a short direction.
(3) In the liquid droplet discharge head according to the above-described (2), the peripheral wall further may include an eave (e.g., the eave 234a) protruding outward of the branched channel member.
(4) The liquid droplet discharge head according to any one of the above-described (1) to (3) may further include an elastic member (e.g., the elastic member 60) between the branched channel member and the reservoir.
(5) The liquid droplet discharge head according to any one of the above-described (1) to (4) may further include, between the branched channel member and the reservoir, an O-ring (e.g., the O-ring 80) configured to seal a connecting portion of the branched channel and the reservoir.
(6) In the liquid droplet discharge head according to any one of the above-described (1) to (5), the branched channel member and the reservoir may be fixed at both end portions of the liquid droplet discharge head in a longitudinal direction.
(7) In the liquid droplet discharge head according to any one of the above-described (1) to (6), the branched channel member and the reservoir may be fixed with a waterproof fixing material (e.g., the fixing materials 90a and 90b).
(8) The liquid droplet discharge head according to any one of the above-described (1) to (7) may further include a heat dissipation plate with a plate shape that is long in a longitudinal direction of the liquid droplet discharge head, in which the heat dissipation plate, the branched channel member and the reservoir may be fixed with a waterproof fixing material (e.g., the fixing material 70d).
(9) The liquid droplet discharge head according to any one of the above-described (1) to (8) may further include a heat dissipation plate with a plate shape that is long in a longitudinal direction of the liquid droplet discharge head, in which the branched channel member and the reservoir may be fixed with a waterproof first fixing material (e.g., the fixing materials 90a and 90b), the branched channel member and the reservoir, and the heat dissipation plate may be fixed with a waterproof second fixing material (e.g., the fixing material 70d), and a region, in a gap between the branched channel member and the reservoir and the heat dissipation plate, where the first fixing material and the second fixing material make contact with each other may be sealed with a caulking material.
(10) The liquid droplet discharge head according to any one of the above-described (1) to (9) may further include: a head cover attached to a head main body; and a heat dissipation plate with a plate shape that is long in a longitudinal direction of the liquid droplet discharge head, in which the reservoir and the heat dissipation plate may be fixed with a waterproof second fixing material, the head cover and the heat dissipation plate may be fixed with a waterproof third fixing material (e.g., the fixing materials 70a to 70c), and a region, in a gap between the reservoir and the head cover and the heat dissipation plate, where both the second fixing material and the third fixing material are not present may be sealed with a caulking material.
(11) The liquid droplet discharge head according to any one of the above-described (1) to (10) may further include a heat dissipation plate with a plate shape that is long in a longitudinal direction of the liquid droplet discharge head, in which the heat dissipation plate and the reservoir may be fixed with a fixing member (e.g., the fixing member 50), the fixing member including a shaft and a head located at an end portion of the shaft, the shaft including a spiral groove at an outer periphery, and the heat dissipation plate may include a recess (e.g., the recess 47) configured to house the head.
(12) In the liquid droplet discharge head according to any one of the above-described (2) to (11), a part of the reservoir may be located in a region surrounded by the bottom and the peripheral wall of the branched channel member.
(13) The liquid droplet discharge head according to any one of the above-described (1) to (12) may further include: a driver IC configured to control driving of a head main body; a heat dissipation plate configured to dissipate heat generated at the driver IC; and a fixer (e.g., the fixer 161c, 162c, 163d) directly or indirectly fixed to the branched channel member, in which the heat dissipation plate and the fixer may be fixed at both end portions of the head main body in a longitudinal direction.
(14) The liquid droplet discharge head according to the above-described (13) may further include a pressing member configured to press the driver IC against the heat dissipation plate, in which the fixer may be provided at both end portions of the pressing member in the longitudinal direction of the liquid droplet discharge head.
(15) The liquid droplet discharge head according to the above-described (13) may further include: a flexible substrate including the driver IC mounted thereon, the flexible substrate being electrically connected to the head main body; a wiring board (e.g., the wiring board 32) electrically connected to the flexible substrate; and a plurality of supporting members (e.g., the supporting member 160) configured to support the wiring board, in which the plurality of supporting members may include: a first supporting member (e.g., the first supporting member 161) configured to support one end portion of a wiring board in the longitudinal direction of the liquid droplet discharge head, and a second supporting member (e.g., the second supporting member 162) configured to support the other end portion of the wiring board in the longitudinal direction of the liquid droplet discharge head, and the fixer may be provided at the first supporting member and the second supporting member.
(16) The liquid droplet discharge head according to the above-described (15) may further include: two heat dissipation plates located at both end portions of the head main body in a width direction; at least two first male screws (e.g., the first male screw 190) inserted to one of the two heat dissipation plates; and at least two second male screws (e.g., the second male screw 191) inserted to the other of the two heat dissipation plates, the first supporting member and the second supporting member may include a cylinder (e.g., the cylinder 167) that is open at both ends in the width direction of the head main body and provided with a screw groove formed in an inner peripheral surface, and the first male screw and the second male screw may be fastened to the same cylinder.
(17) The liquid droplet discharge head according to any one of the above-described (13) to (16) may further include a plate member (e.g., the plate member 170) made of resin and configured to join the heat dissipation plate and the branched channel member.
(18) A droplet discharge apparatus may include: the liquid droplet discharge head according to any one of any one of the above-described (1) to (17); and a controller configured to control the liquid droplet discharge head.

The embodiments disclosed here should in all respects be considered illustrative and not restrictive. Indeed, the embodiments described above may be embodied in a variety of forms. The above embodiments may also be omitted, replaced or modified in various forms without departing from the scope and intent of the appended claims.

1. A liquid droplet discharge head comprising:
a channel member including a plurality of discharge holes for discharging droplets;
a branched channel member located over the channel member and comprising a branched channel connected to the channel member; and
a reservoir located over the branched channel member and configured to supply liquid to the branched channel member, wherein
the branched channel member has a box shape.

2. The liquid droplet discharge head according to claim 1, wherein
the branched channel member comprises a bottom located over the channel member, and a peripheral wall provided upright from the bottom,
the bottom comprises a contact surface that makes contact with the channel member, and a box bottom surface located opposite to the contact surface, and
a height of the peripheral wall with respect to the box bottom surface is greater than 20% of a width of the bottom in a short direction.

3. The liquid droplet discharge head according to claim 2, wherein the peripheral wall further comprises an eave protruding outward of the branched channel member.

4. The liquid droplet discharge head according to claim 1, further comprising an elastic member between the branched channel member and the reservoir.

5. The liquid droplet discharge head according to claim 1, further comprising, between the branched channel member and the reservoir, an O-ring configured to seal a connecting portion of the branched channel and the reservoir.

6. The liquid droplet discharge head according to claim 1, wherein the branched channel member and the reservoir are fixed at both end portions of the liquid droplet discharge head in a longitudinal direction.

7. The liquid droplet discharge head according to claim 6, wherein the branched channel member and the reservoir are fixed with a waterproof fixing material.

8. The liquid droplet discharge head according to claim 1, further comprising a heat dissipation plate with a plate shape that is long in a longitudinal direction of the liquid droplet discharge head, wherein
the heat dissipation plate, and the branched channel member and the reservoir are fixed with a waterproof fixing material.

9. The liquid droplet discharge head according to claim 1, further comprising a heat dissipation plate with a plate shape that is long in a longitudinal direction of the liquid droplet discharge head, wherein
the branched channel member and the reservoir are fixed with a waterproof first fixing material,
the branched channel member and the reservoir, and the heat dissipation plate are fixed with a waterproof second fixing material, and
a region, in a gap between the branched channel member and the reservoir and the heat dissipation plate, where the first fixing material and the second fixing material make contact with each other is sealed with a caulking material.

10. The liquid droplet discharge head according to claim 1, further comprising:
a head cover attached to a head main body; and
a heat dissipation plate with a plate shape that is long in a longitudinal direction of the liquid droplet discharge head, wherein
the reservoir and the heat dissipation plate are fixed with a waterproof second fixing material,
the head cover and the heat dissipation plate are fixed with a waterproof third fixing material, and
a region, in a gap between the reservoir and the head cover and the heat dissipation plate, where both the second fixing material and the third fixing material are not present is sealed with a caulking material.

11. The liquid droplet discharge head according to claim 1, further comprising a heat dissipation plate with a plate shape that is long in a longitudinal direction of the liquid droplet discharge head, wherein
the heat dissipation plate and the reservoir are fixed with a fixing member, the fixing member comprising a shaft and a head located at an end portion of the shaft, the shaft comprising a spiral groove at an outer periphery, and
the heat dissipation plate comprises a recess configured to house the head.

12. The liquid droplet discharge head according to claim 2, wherein a part of the reservoir is located in a region surrounded by the bottom and the peripheral wall of the branched channel member.

13. The liquid droplet discharge head according to claim 1, further comprising:
a driver IC configured to control driving of a head main body;
a heat dissipation plate configured to dissipate heat generated at the driver IC; and
a fixer directly or indirectly fixed to the branched channel member, wherein
the heat dissipation plate and the fixer are fixed at both end portions of the liquid droplet discharge head in a longitudinal direction.

14. The liquid droplet discharge head according to claim 13, further comprising a pressing member configured to press the driver IC against the heat dissipation plate, wherein
the fixer is provided at both end portions of the pressing member in the longitudinal direction of the liquid droplet discharge head.

15. The liquid droplet discharge head according to claim 13, further comprising:
a flexible substrate comprising the driver IC mounted thereon, the flexible substrate being electrically connected to the head main body;
a wiring board electrically connected to the flexible substrate; and
a plurality of supporting members configured to support the wiring board, wherein
the plurality of supporting members comprises:
a first supporting member configured to support one end portion of a wiring board in the longitudinal direction of the liquid droplet discharge head, and
a second supporting member configured to support the other end portion of the wiring board in the longitudinal direction of the liquid droplet discharge head, and
the fixer is provided at the first supporting member and the second supporting member.

16. The liquid droplet discharge head according to claim 15, further comprising:
two heat dissipation plates located at both end portions of the liquid droplet discharge head in a width direction;
at least two first male screws inserted to one of the two heat dissipation plates; and
at least two second male screws inserted to the other of the two heat dissipation plates, wherein
the first supporting member and the second supporting member comprise a cylinder that is open at both ends in the width direction of the liquid droplet discharge head and provided with a screw groove formed in an inner peripheral surface, and
the first male screw and the second male screw are fastened to the same cylinder.

17. The liquid droplet discharge head according to claim 13, further comprising a plate member made of resin and configured to join the heat dissipation plate and the branched channel member.

18. A droplet discharge apparatus comprising:
the liquid droplet discharge head according to claim 1; and
a controller configured to control the liquid droplet discharge head.
